(19) United States
(12) Patent Application Publication
(10) Pub. No.: US 2026/0288074 A1
(43) Pub. Date: Sep. 24, 2026

(54) DECORATIVE BEZEL, DECORATIVE BEZEL UNIT, AND TIMEPIECE

(71) Applicant: CASIO COMPUTER CO., LTD., Tokyo (JP)

(72) Inventors: Junichirou SUZUKI, Tokyo (JP); Kazumasa YOKOO, Tokyo (JP); Masaki MIYATA, Tokyo (JP); Kazuma KOBAYASHI, Tokyo (JP)

(73) Assignee: CASIO COMPUTER CO., LTD., Tokyo (JP)

(21) Appl. No.: 19/085,295

(22) Filed: Mar. 20, 2025

(30) Foreign Application Priority Data
Mar. 21, 2024 (JP) 2024-044378

(51) Int. Cl. G04B 45/00

(52) U.S. Cl. CPC G04B 45/0069

(57) ABSTRACT

A decorative bezel includes an inner side surface including a flat surface region that abuts a flat surface region of an outer side surface of a rigid timepiece case in a state in which the decorative bezel is disposed around the timepiece case. The decorative bezel is made of a brittle material.

### CROSS-REFERENCE TO RELATED APPLICATIONS

This application is based upon and claims the benefit of priority from the prior Japanese Patent Application No. 2024-044378, filed on Mar. 21, 2024, the entire contents of which are incorporated herein by reference.

### TECHNICAL FIELD

The present disclosure relates to a decorative bezel, a decorative bezel unit, and a timepiece.

### DESCRIPTION OF RELATED ART

In JP 2021-169968 A, there is disclosed a wristwatch including a protective member for a crown. The protective member is fixed to the side surface of an exterior case with a bolt(s). If a brittle material such as sapphire is used for a decorative bezel such as the aforementioned protective member, it is difficult to dispose the decorative bezel not to be damaged.

### SUMMARY OF THE INVENTION

According to an aspect of the present disclosure, there is provided a decorative bezel including an inner side surface including a flat surface region that abuts a flat surface region of an outer side surface of a rigid timepiece case in a state in which the decorative bezel is disposed around the timepiece case, wherein the decorative bezel is made of a brittle material.

### BRIEF DESCRIPTION OF DRAWINGS

FIG. 1 is a front view of the main part of a timepiece according to an embodiment(s) of the present disclosure.

FIG. 2 is an exploded perspective view of the main part of the timepiece according to the embodiment.

FIG. 3 is a partial sectional view of the timepiece taken along line III-III in FIG. 1.

FIG. 4 is a partial sectional view of the timepiece taken along line IV-IV in FIG. 1.

FIG. 5 illustrates abutment surfaces of a side bezel and a timepiece case according to the embodiment.

FIG. 6 is a partial sectional view of the timepiece taken along line VI-VI in FIG. 1.

FIG. 7 is an exploded perspective view of a corner bezel according to the embodiment.

FIG. 8 is a partial sectional view of the timepiece taken along line VIII-VIII in FIG. 1.

FIG. 9A illustrates a modification of a divided pattern of decorative bezels according to the embodiment.

FIG. 9B illustrates another modification of the divided pattern of decorative bezels according to the embodiment.

### DETAILED DESCRIPTION

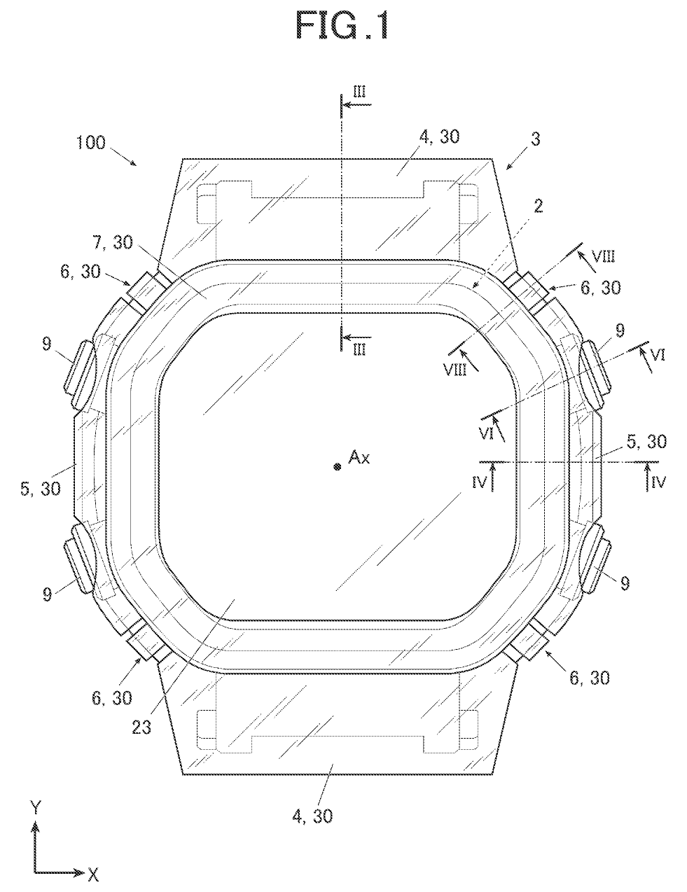

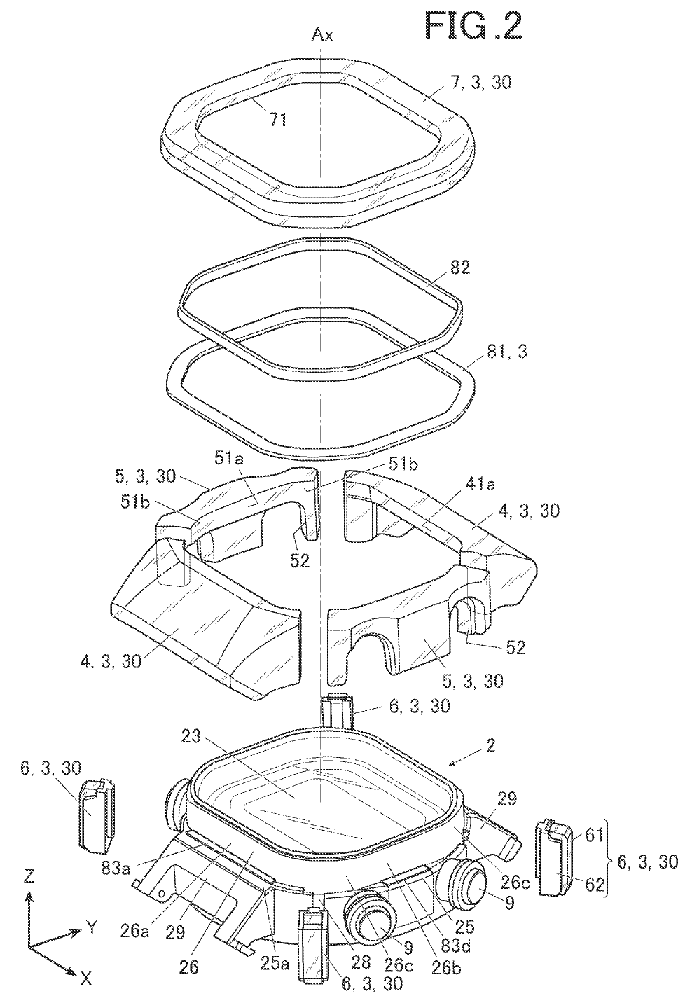

Hereinafter, one or more embodiments of the present disclosure will be described with reference to the drawings. As illustrated in FIG. 1 and FIG. 2, a timepiece 100 according to an embodiment(s) is a wristwatch that is worn on a wrist of a user. The timepiece 100 includes a timepiece case 2 and a bezel unit 3. Hereinafter, X, Y, Z directions of the timepiece 100 refer to those illustrated in the drawings. That is, the X direction and the Y direction refer to the 3:00-9:00 direction and the 12:00-6:00 direction in an analog timepiece, respectively, and the Z direction refers to the front-back direction of the timepiece 100 (timepiece case 2). In the Z direction, the visible side, which is the front side, may be referred to as the “upper side” or “upward”, and the back side may be referred to as the “lower side” or “downward”. Directions perpendicular to a central axis Ax of the timepiece case 2, the central axis Ax being parallel to the Z direction, are referred to as the “radial direction”, and a rotational direction around the central axis Ax is referred to as the “circumferential direction”. In a plane perpendicular to the central axis Ax, a side closer to the central axis Ax is referred to as the “inner side”, “inner diameter side” or the like, and a side far from the central axis Ax is referred to as the “outer side”, “outer diameter side” or the like.

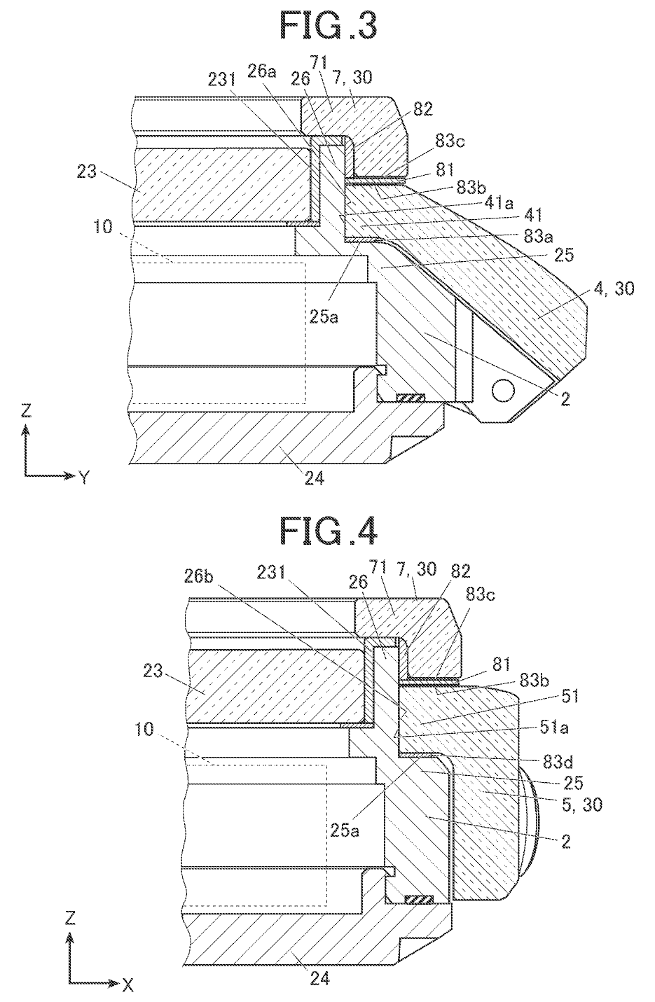

The timepiece case 2 is formed in an approximately rectangular tubular shape as viewed from above, namely, in front view or top view, and the opening on the front side (upper side) is closed with a transparent crystal 23 (windshield glass) that transmits visible light, and the opening on the back side (lower side) is closed with a back cover 24 (in FIG. 3, etc.). The material of the timepiece case 2 is, for example, metal, such as titanium or stainless steel, or hard resin, such as carbon. The material of the timepiece case 2 is not limited thereto, but any material as far as it is not a brittle material and can make the timepiece case 2 rigid. In this embodiment, it is preferable that the rigidity of the material of a “rigid” object be greater than that of a brittle material of an object that is in contact with the rigid object. However, as far as the rigid object is not made of a brittle material, it is acceptable. In the timepiece case 2, a timepiece module 10 (in FIG. 3, etc.) is housed. The timepiece module 10 includes, for example, a time display that displays time, a battery that serves as a power source, and a circuit board on which a control circuit is mounted. The top view shape of the timepiece case 2 is not limited to the rectangular tubular shape, and therefore may be a polygonal shape other than the rectangle shape, a circular shape, or the like.

As illustrated in FIGS. 2 and 3, on the outer side surface of the timepiece case 2, a stepped part 25 is formed over approximately the entire periphery (circumference) of the timepiece case 2 so as to spread radially outward from its upper side to lower side stepwise. The stepped part 25 has a tread surface 25athat is approximately perpendicular to the Z direction and faces upward. Of the timepiece case 2, a part above the stepped part 25 is a tubular part 26 having a rounded-corner-rectangular tubular shape in top view. The crystal 23 is fitted to the inner diameter side of the tubular part 26 with a first packing 231 in between.

The bezel unit 3 is an example of the decorative bezel unit according to the present disclosure, and includes two front bezels 4, two side bezels 5, four corner bezels 6, a top bezel 7, and a spacer 81. Of the bezel unit 3, decorative bezels 30, which are not below-described holding members 62 of the corner bezels 6 and the spacer 81, but the front bezels 4, the side bezels 5, below-described corner bezel bodies 61 of the corner bezels 6 and the top bezel 7, are made of a translucent material(s) that transmits visible light, such as sapphire glass. The material of the decorative bezels 30 is not limited to a translucent material, but any material in a wide range of brittle materials, which include inorganic glass, ceramics, and shells. Although not particularly limited, all the surfaces of each decorative bezel 30 are mirror-finished to a predetermined level of smoothness.

Of the bezel unit 3, the bezels excluding the top bezel 7, namely, the two front bezels 4, the two side bezels 5 and the four corner bezels 6, are disposed to form an annular shape in the plane perpendicular to the Z direction to cover the outer side surface of the timepiece case 2. The front bezels 4 and the side bezels 5 are examples of a second bezel(s) according to the present disclosure, and are disposed on the side (outer side) of the timepiece case 2. More specifically, the two front bezels 4 and the two side bezels 5 are disposed to correspond to the four sides of the approximately rectangular tubular timepiece case 2. The corner bezels 6 are examples of a third bezel(s) according to the present disclosure, and each are disposed, of the front bezels 4 and the side bezels 5, two bezels adjacent to one another. That is, the corner bezels 6 are disposed at the four corners of the timepiece case 2.

The two front bezels 4 are disposed on both sides of the timepiece case 2 in the Y direction. Each front bezel 4 is formed in a shape extending in the X direction to correspond to a side of the timepiece case 2 in the Y direction. Also, each front bezel 4 is disposed to cover the upper side of a strap attachment part 29 of the timepiece case 2, the strap attachment part 29 to which a strap (not illustrated) is attached. Each front bezel 4 is formed in an approximately inclined-plate shape that declines as its position in the Y direction is far from the central axis Ax to correspond to the shape of the strap attachment part 29.

Of each front bezel 4, an end part 41 on the inner diameter side abuts the timepiece case 2 and is fixed thereto. More specifically, the inner side surface of the end part 41 excluding both side parts in the X direction, namely, the center part in the X direction, is a first abutment surface 41a that is a flat surface. Of the timepiece case 2, parts corresponding to the first abutment surfaces 41a are first case-side flat surfaces 26a that are both side parts of the outer side surface of the tubular part 26 in the Y direction and are approximately perpendicular to the radial direction. In a state in which the front bezels 4 are disposed around the timepiece case 2, the first abutment surfaces 41a abut the first case-side flat surfaces 26a of the timepiece case 2. The lower surfaces of the end parts 41 of the front bezels 4 abut the tread surface 25a of the timepiece case 2 with double-sided tape 83a in between. In other words, the lower surfaces of the end parts 41 are adhered to the tread surface 25a of the timepiece case 2 with the double-sided tape 83a.

As illustrated in FIGS. 2, 4 and 5, the two side bezels 5 are disposed on both sides of the timepiece case 2 in the X direction. Each side bezel 5 is formed in a shape extending in the Y direction to correspond to a side of the timepiece case 2 in the X direction.

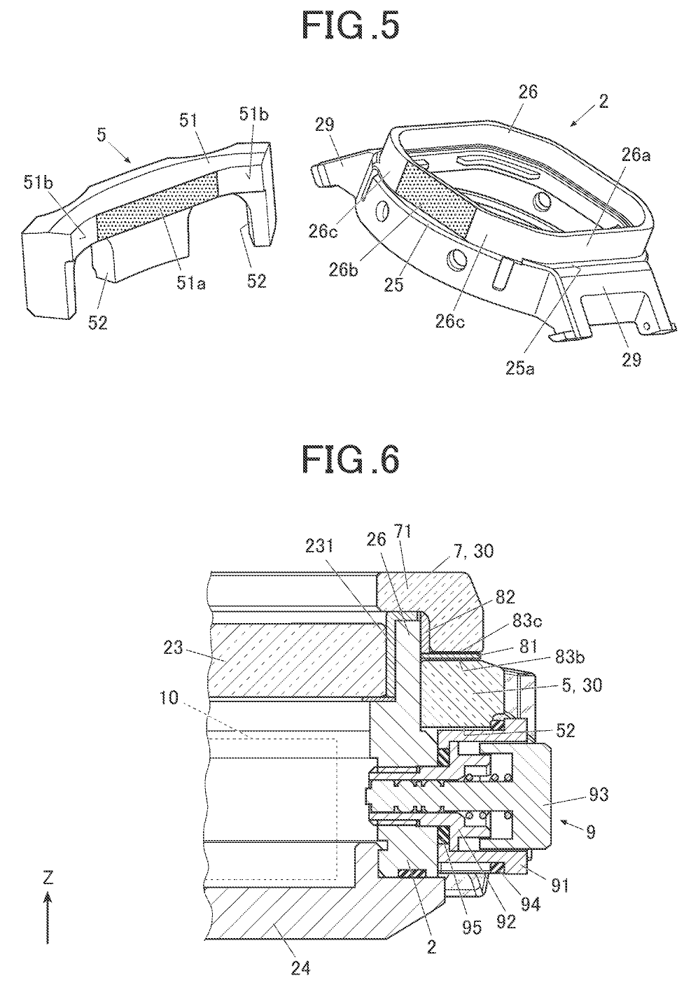

Of each size bezel 5, an end part 51 on the inner diameter side abuts the timepiece case 2 and is fixed thereto. More specifically, the inner side surface of the end part 51 excluding both side parts in the Y direction, namely, the center part in the Y direction, is a second abutment surface 51a that is a flat surface. Of the timepiece case 2, parts corresponding to the second abutment surfaces 51a are second case-side flat surfaces 26b that are both side parts of the outer side surface of the tubular part 26 in the X direction and are approximately perpendicular to the radial direction. In a state in which the side bezels 5 are disposed around the timepiece case 2, the second abutment surfaces 51a abut the second case-side flat surfaces 26b of the timepiece case 2. The lower surfaces of the end parts 51 of the side bezels 5 abut the tread surface 25a of the timepiece case 2 with double-sided tape 83d in between. In other words, the lower surfaces of the end parts 51 of the side bezels 5 are adhered to the tread surface 25a of the timepiece case 2 with the double-sided tape 83d. The end parts 51 of the side bezels 5 are approximately the same as the end parts 41 of the front bezels 4 in height position in the Z direction. In FIG. 5, the second abutment surface 51a and the second case-side flat surface 26b are shown with a dot pattern to be easily recognized. The surface states of these flat surface regions are not particularly limited.

In each side bezel 5, of the inner side surface of the end part 51, the both side parts in the Y direction, which are not the second abutment surface 51a, are first curved surfaces 51b. Of the timepiece case 2, parts corresponding to the first curved surfaces 51b are first case-side curved surfaces 26c at the four corners of the outer side surface of the tubular part 26. It is preferable that, in the state in which the side bezels 5 are disposed around the timepiece case 2, the first curved surfaces 51b be spaced apart from (i.e., do not abut) the first case-side curved surfaces 26c of the timepiece case 2. This enables the second abutment surfaces 51aof the side bezels 5 to abut the second case-side flat surfaces 26b of the timepiece case 2 more reliably. It is sufficient that the first curved surfaces 51bof the side bezels 5 be partly spaced apart from the first case-side curved surfaces 26c of the timepiece case 2, and therefore the first curved surfaces 51b may partly abut the first case-side curved surfaces 26c due to, for example, processing errors or the like.

As illustrated in FIGS. 2 and 6, at parts of each side bezel 5 corresponding to operation buttons 9, U-shaped clearance grooves (undercuts) 52 that open downward are formed. Each operation button 9 is fixed to a part of the timepiece case 2 under the tubular part 26, in a state in which the operation button 9 extends in a direction that intersects both the X direction and the Y direction and is approximately parallel to the radial direction. Each operation button 9 includes a decorative piece 91, a button pipe 92, and a push button 93. The decorative piece 91 is formed in an approximately cylindrical shape, and is disposed in its corresponding clearance groove 52 in a state in which an impact absorber 94 (e.g., made of nitrile rubber) is sandwiched between the decorative piece 91 and the side bezel 5 so that the decorative piece 91 does not come into direct contact with the side bezel 5. The side bezel 5 is pressed radially inward by the decorative piece 91 with the impact absorber 94 in between. The button pipe 92 is inserted in the decorative piece 91, and screwed to the timepiece case 2 in a state in which the flange of the bottom pipe 92 projecting on the outer diameter side holds the decorative piece 91. The gap between the button pipe 92 and the timepiece case 2 is sealed with an O-ring 95. The push button 93 is inserted in the button pipe 92 and supported thereby to be pressable in the radial direction. If the timepiece 100 employs an analog display method and includes a crown, the side bezels 5 in such a case may be configured in the same manner as the side bezels 5 in this embodiment to avoid contact with the crown.

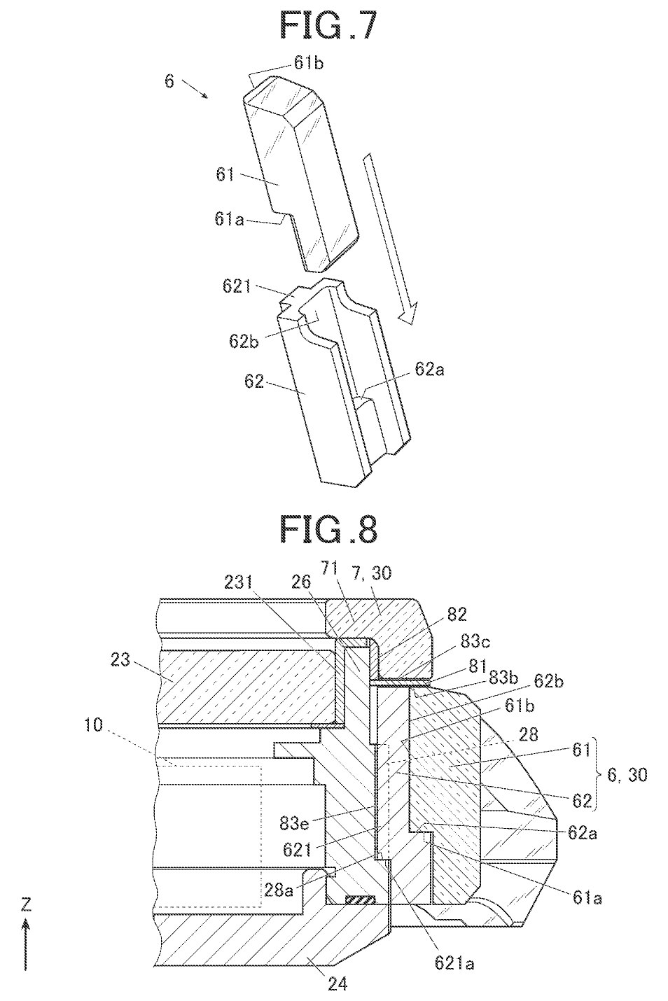

As illustrated in FIGS. 1, 2, 7 and 8, the four corner bezels 6 are disposed at the corners between the front bezels 4 and the side bezels 5 of the timepiece 100 in top view. Each corner bezel 6 includes a corner bezel body 61 and a holding member 62 that holds the corner bezel body 61. The corner bezel body 61 is formed in an approximately rectangular column shape that is long in the Z direction. The surface of the corner bezel body 61 corresponding to the inner diameter side of the timepiece case 2, namely, the surface on the inner diameter side of the corner bezel body 61, is formed stepwise and has a tread surface 61a facing downward. The holding member 62 has a groove that opens radially outward and extends in the Z direction, and houses the corner bezel body 61 in the groove. In the groove, the holding member 62 has a tread surface 62a facing upward that corresponds to the tread surface 61a of the corner bezel body 61. The corner bezel body 61 is adhered to the holding member 62 with an adhesive in a state in which the tread surface 61a abuts the tread surface 62a of the holding member 62 in the Z direction, and an end surface 61b on the inner diameter side abuts a groove bottom surface 62b of the holding member 62 in the radial direction. The method for adhering the corner bezel body 61 to the holding member 62 is not limited to an adhesive, but, for example, double-sided tape or the like. On the surface on the inner diameter side of the holding member 62, a projection 621 extending in the Z direction is formed. At each of the four corners of the timepiece case 2, a groove 28 (in FIG. 2) extending in the Z direction is formed to correspond to the projection 621. Each corner bezel 6 is disposed at a corner of the timepiece case 2 by the projection 621 of the holding member 62 of the corner bezel 6 being fitted in the groove 28 of the timepiece case 2. The top surface of the projection 621 of the holding member 62 is adhered to the bottom surface of the groove 28 of the timepiece case 2 with double-sided tape 83e. At the time, a tread surface 621afacing downward at the lower end of the projection 621 of the holding member 62 abuts a tread surface 28a facing upward in the groove 28 of the timepiece case 2. The holding member 62 is an example of a spacer according to the present disclosure, and is interposed between the front bezel 4 and the side bezel 5 in the circumferential direction, or between the front bezel 4 or the side bezel 5 and the corner bezel body 61 in the circumferential direction. The material of the holding member 62 is, for example, metal, such as titanium or stainless steel, or hard resin, such as carbon. The material of the holding member 62 is not limited thereto, but any material as far as it is not a brittle material and can make the holding member 62 rigid.

The top bezel 7 is an example of a first bezel according to the present disclosure, and is disposed above the timepiece case 2 as illustrated in FIG. 2 and FIG. 3. The top bezel 7 is formed in a rectangular annular shape in top view to correspond to the shape of the timepiece case 2 in top view, and has a flange 71 projecting inward over the entire periphery. The top bezel 7 is fixed to the timepiece case 2 by being press-fitted to the outer diameter side of the tubular part 26 of the timepiece case 2. Between the top bezel 7 and the tubular part 26, a second packing 82 is disposed so that the top bezel 7 and the tubular part 26 do not come into direct contact with one another. The second packing 82 is made of a material different from that of the first packing 231, and is lower in hardness (softer) than the first packing 231. The flange 71 of the top bezel 7 is disposed above the tubular part 26 and the first packing 231 so that the tubular part 26 and the first packing 231 are invisible from the front side.

Between the top bezel 7 and the timepiece case 2, the front bezels 4, the side bezel 5 and the corner bezels 6, which are annularly disposed, are sandwiched in the Z direction, thereby being fixed. More specifically, the end part 41 of each front bezel 4 is fixed between the tread surface 25a of the timepiece case 2 and the lower end surface of the top bezel 7, and the end part 51 of each side bezel 5 is fixed between the tread surface 25a of the timepiece case 2 and the lower end surface of the top bezel 7. As to each corner bezel 6, the holding member 62 is fixed between the tread surface 28a of the timepiece case 2 and the lower end surface of the top bezel 7, and the corner bezel body 61 is fixed between the tread surface 62a of the holding member 62 and the lower end surface of the top bezel 7.

Between the top bezel 7 and the bezels 4, 5, 6, the spacer 81 made of metal (e.g., titanium) is interposed so that the top bezel 7 and the bezels 4, 5, 6 (corner bezel bodies 61) do not come into direct contact with one another. The spacer 81 is formed in a rectangular annular shape in top view to correspond to the shape of the top bezel 7 in top view, and is disposed under the top bezel 7 over the entire periphery of the timepiece case 2. To the lower surface of the spacer 81, double-sided tape 83b is attached, and this double-sided tape 83b adheres the spacer 81 to the front bezels 4, the side bezels 5 and the corner bezels 6 (corner bezel bodies 61 and holding members 62). To the upper surface of the spacer 81, double-sided tape 83c is attached, and this double-sided tape 83c adheres the spacer 81 to the top bezel 7. The material of the spacer 81 is, for example, metal, such as titanium or stainless steel, or hard resin, such as carbon. The material of the spacer 81 is not limited thereto, but any material as far as it is not a brittle material and can make the spacer 81 rigid.

Next, a procedure for combining the bezel unit 3 with the timepiece case 2 will be described. It is assumed that the timepiece module 10 has been housed in the timepiece case 2, the crystal 23 and the back cover 24 have been attached to the timepiece case 2, and the operation buttons 9 have been combined with the timepiece case 2 beforehand. It is also assumed that the four corner bezels 6 each have been assembled beforehand.

First, as illustrated in FIGS. 2 and 8, the four corner bezels 6 are attached to the four corners of the timepiece case 2. More specifically, the corner bezels 6 are disposed at the respective corners of the timepiece case 2 by the projections 621 on the inner diameter side of the holding members 62 of the corner bezels 6 being fitted into the grooves 28 at the respective corners of the timepiece case 2. Each corner bezel 6 is tentatively fixed by being adhered to the bottom surface of the groove 28 of the timepiece case 2 with the double-sided tape 83e attached to the top surface of the projection 621. At the time, the tread surface 621afacing downward at the lower end of the projection 621 of the holding member 62 is made to abut the tread surface 28a facing upward in the groove 28 of the timepiece case 2.

Next, as illustrated in FIGS. 2, 3 and 4, the two front bezels 4 and the two side bezels 5 are attached to the timepiece case 2 in sequence. Each front bezel 4 is tentatively fixed by the lower surface of the end part 41 being adhered to the tread surface 25a of the timepiece case 2 with the double-sided tape 83a in the state in which the first abutment surface 41a of the end part 41 abuts the first case-side flat surface 26a of the timepiece case 2 in the radial direction. Each side bezel 5 is tentatively fixed by the lower surface of the end part 51 being adhered to the tread surface 25a of the timepiece case 2 with the double-sided tape 83d in the state in which the second abutment surface 51a of the end part 51 abuts the second case-side flat surface 26b of the timepiece case 2 in the radial direction. At the time, the upper end surfaces of the front bezels 4, the side bezels 5 and the corner bezels 6 are approximately flush with one another in the plane approximately perpendicular to the Z direction.

Next, the spacer 81 is disposed in the timepiece case 2. The spacer 81 with the double-sided tapes 83c, 83battached to its upper surface and lower surface, respectively, is inserted into the tubular part 26, thereby being disposed in the timepiece case 2. The spacer 81 is tentatively fixed by being adhered to the upper surfaces of the front bezels 4, the side bezels 5 and the corner bezels 6 with the double-sided tape 83b attached to the lower surface of the spacer 81.

Next, the top bezel 7 is attached to the timepiece case 2. The top bezel 7 is press-fitted from above to the outer diameter side of the tubular part 26 of the timepiece case 2 with the second packing 82 in between, the second packing 82 being disposed in advance on the outer diameter side of the tubular part 26. The top bezel 7 is press-fitted until it sufficiently abuts the front bezels 4, the side bezels 5 and the corner bezels 6 with the spacer 81 in between. Thus, the front bezels 4, the side bezels 5 and the corner bezels 6 are appropriately fixed in the state in which they are sandwiched between the timepiece case 2 and the top bezel 7.

Objects of the present disclosure include appropriately decorating a timepiece case with a decorative bezel(s) made of a brittle material. As described above, according to this embodiment, in the state in which the decorative bezels 30 made of a brittle material(s) are disposed around the rigid timepiece case 2, the flat surface region of the inner side surface of each decorative bezel 30 abuts its corresponding flat surface region of the outer side surface of the timepiece case 2. More specifically, the timepiece case 2 has the outer side surface including the first case-side flat surfaces 26a and the second case-side flat surfaces 26b each as the flat surface region, and, of the decorative bezels 30, for example, the front bezels 4 each have the inner side surface including the first abutment surface 41a as the flat surface region, and the side bezels 5 each have the inner side surface including the second abutment surface 51a as the flat surface region. In the state in which the front bezels 4 are disposed around the timepiece case 2, the first abutment surface 41a of each front bezel 4 abuts its corresponding first case-side flat surface 26a of the timepiece case 2, and in the state in which the side bezels 5 are disposed around the timepiece case 2, the second abutment surface 51a of each side bezel 5 abuts its corresponding second case-side flat surface 26b of the timepiece case 2. Thus, the front bezels 4 and the side bezels 5 made of a brittle material can be brought into surface contact with the rigid timepiece case 2. This can prevent movement of the front bezels 4 and the side bezels 5 at the time of an impact. In general, a support member for absorbing an impact is made of an elastic material. However, if the brittle material, such as sapphire, is supported by an elastic material, the brittle material may be broken at the time of an impact due to excessive deformation. Preventing movement of the front bezels 4 and the side bezels 5 at the time of an impact can prevent damage to these decorative bezels 30, and, by extension, can enhance the impact resistance of the timepiece 100. Thus, the timepiece case 2 can be appropriately decorated with the decorative bezels 30 made of a brittle material.

Furthermore, according to this embodiment, in the state in which the side bezels 5 are disposed around the timepiece case 2, the first curved surfaces 51b (curved surface regions) of the inner side surface of each side bezel 5 are spaced apart from their corresponding first case-side curved surfaces 26c (curved surface regions) of the outer side surface of the timepiece case 2. This enables the second abutment surfaces 51a of the side bezels 5 to abut the second case-side flat surfaces 26b of the timepiece case 2 more reliably. As with the side bezels 5, in the front bezels 4, curved surfaces (curved surface regions) of the inner side surface of each front bezel 4, which are not the first abutment surface 41a, may be spaced apart from their corresponding curved surfaces (curved surface regions) of the outer side surface of the timepiece case 2, which are not the first case-side flat surface 26a.

Furthermore, according to this embodiment, two or more decorative bezels 30 (front bezels 4, side bezels 5, corner bezels 6 (corner bezel bodies 61), and top bezel 7) are disposed around the timepiece case 2 so as not to come into contact with one another. This can prevent the decorative bezels 30 from coming into direct contact with one another and being damaged. Thus, the timepiece case 2 can be appropriately decorated with the decorative bezels 30.

Furthermore, according to this embodiment, the metallic spacers (spacer 81 and holding members 62) are interposed between the two or more decorative bezels 30. This can prevent damage caused by the decorative bezels 30 contacting one another. Furthermore, the holding members 62, each of which is the metallic spacer and disposed between the front bezel 4 and the side bezel 5, may be formed integrally with the timepiece case 2.

Furthermore, according to this embodiment, the spacer 81 is disposed between the top bezel 7 (first bezel), which is disposed above the timepiece case 2, and the front bezels 4 and the side bezels 5 (second bezels), which are disposed on the side of the timepiece case 2. This can prevent damage caused by the front and side bezels 4, 5 and the top bezel 7 contacting one another.

Furthermore, according to this embodiment, the two or more decorative bezels 30 include one top bezel 7, which is disposed above the timepiece case 2, and two or more front bezel(s) 4 and side bezel(s) 5, which are disposed on the side of the timepiece case 2. In other words, the decorative bezels 30, which are divided bezels into which a bezel is divided in both the up-down direction (Z direction) and the circumferential direction, are disposed in both the up-down direction and the circumferential direction. Therefore, the decorative bezels 30 can be easily and individually made to abut their corresponding parts of the timepiece case 2. Also, since the decorative bezels 30 can be separated in each of the directions, each surface of each decorative bezel 30 can be easily polished and mirror-finished.

Furthermore, according to this embodiment, the timepiece case 2 is formed, in top view, in an approximately (substantially) polygonal shape including sides, and the front bezels 4 and the side bezels 5 (second bezels) are disposed to correspond to the sides of the polygonal timepiece case 2. Thus, the front bezels 4 and the side bezels 5 can be appropriately brought into surface contact with the respective sides of the timepiece case 2, and also the outer side surface of the timepiece case 2 can be appropriately decorated with the front bezels 4 and the side bezels 5.

Furthermore, according to this embodiment, the decorative bezels 30 include the corner bezels 6 (corner bezel bodies 61) (third bezels) each disposed between the front bezel 4 and the side bezel 5 adjacent to one another. Thus, the corners of the timepiece case 2 as well as the sides of the timepiece case 2 can be appropriately decorated.

Embodiments to which the present disclosure is applicable are not limited to the above-described embodiment, and therefore various modifications can be made without departing from the scope of the present disclosure. For example, in the above embodiment, the decorative bezels 30, with which the timepiece case 2 is decorated, are divided bezels disposed in both the circumferential direction and the up-down direction of the timepiece case 2. However, the divided pattern of decorative bezels according to the present disclosure is not particularly limited as far as they can be disposed around the timepiece case so as not to come into contact with one another.

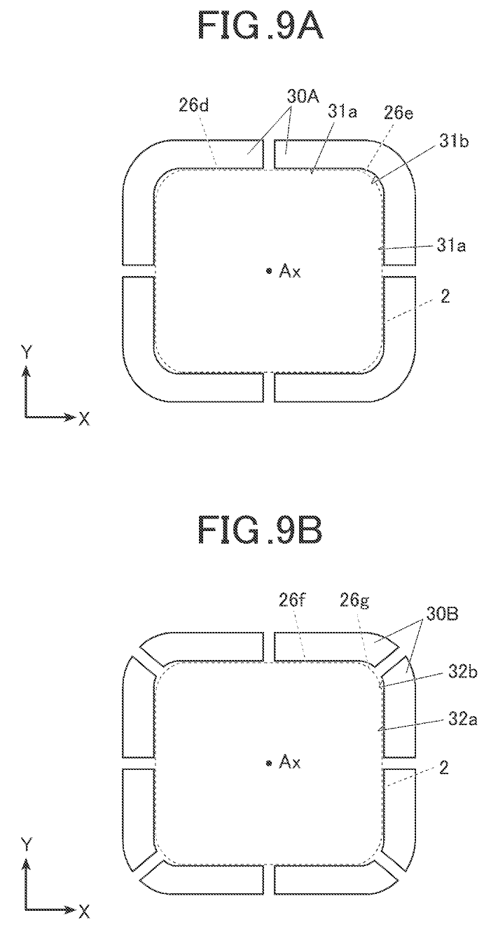

For example, although in the above embodiment, the front bezels 4 and the side bezels 5 are disposed to correspond to the respective sides of the timepiece case 2, and the corner bezels 6 are disposed between the front bezels 4 and the side bezels 5, the divided pattern in the circumferential direction is not limited thereto. For example, decorative bezels 30Aeach extending across two sides of the timepiece case 2 adjacent to one another, thereby covering a corner formed by the two sides, may be disposed as illustrated in FIG. 9A. In this case, one of two flat surface regions 31a at both sides of each decorative bezel 30A abuts, of the timepiece case 2, a flat surface region 26d that the one faces. It is preferable that a curved surface region 31bbetween the two flat surface regions 31a of each decorative bezel 30A be spaced apart from, of the timepiece case 2, a curved surface region 26e that the curved surface region 31b faces.

Alternatively, decorative bezels 30B each extending from a corner of the timepiece case 2 to a point of a side adjacent to the corner may be disposed as illustrated in FIG. 9B. In this case, it is preferable that the decorative bezels 30 be divided bezels that do not interfere with the operation buttons 9 (and the crown) and are not difficult to assemble. In this case, a flat surface region 32a of each decorative bezel 30B abuts, of the timepiece case 2, a flat surface region 26f that the flat surface region 32a faces. It is preferable that a curved surface region 32b of each decorative bezel 30B, which is not the flat surface region 32a, be spaced apart from, of the timepiece case 2, a curved surface region 26g that the curved surface region 32b faces.

Furthermore, as to the abutment surface (i.e., contact surface) of each decorative bezel 30 to the timepiece case 2, as far as movement of the decorative bezel 30 can be restricted, its position is not particularly limited. For example, the abutment surface may be present not at the center of each decorative bezel 30 but at an end thereof. It is preferable that the abutment surface of each decorative bezel 30 be set so as to ensure as wide an area as possible in accordance with the divided pattern of decorative bezels 30.

Furthermore, to/on the lower surface of each decorative bezel 30 (e.g., the lower surface of the top bezel 7) made of a translucent material, an opaque layer may be applied or vapor-deposited so that the internal components, such as the double-sided tapes, are invisible from the front side.

1. A decorative bezel comprising an inner side surface including a flat surface region that abuts a flat surface region of an outer side surface of a rigid timepiece case in a state in which the decorative bezel is disposed around the timepiece case,
wherein the decorative bezel is made of a brittle material.

2. The decorative bezel according to claim 1, wherein the inner side surface further includes a curved surface region that is spaced apart from a curved surface region of the outer side surface of the timepiece case in the state in which the decorative bezel is disposed around the timepiece case.

3. A decorative bezel unit comprising decorative bezels each being the decorative bezel according to claim 1,
wherein the decorative bezels are not in contact with one another.

4. The decorative bezel unit according to claim 3, further comprising a metallic spacer interposed between the decorative bezels.

5. The decorative bezel unit according to claim 4, wherein the metallic spacer is formed integrally with the timepiece case.

6. The decorative bezel unit according to claim 4,
wherein the decorative bezels include a first bezel disposed above the timepiece case and a second bezel disposed on side of the timepiece case, and
wherein the metallic spacer is disposed between the first bezel and the second bezel.

7. The decorative bezel unit according to claim 3, wherein the decorative bezels include one first bezel disposed above the timepiece case and two or more second bezels disposed on side of the timepiece case.

8. The decorative bezel unit according to claim 7,
wherein the timepiece case is formed, in top view, in a substantially polygonal shape including sides, and
wherein the second bezels are disposed to correspond to the sides of the polygonal shape.

9. The decorative bezel unit according to claim 8, wherein the decorative bezels include a third bezel disposed between, of the second bezels, two second bezels adjacent to one another.

10. A timepiece comprising:
a timepiece module;
a rigid timepiece case that houses the timepiece module; and
a decorative bezel (i) including an inner side surface including a flat surface region that abuts a flat surface region of an outer side surface of the timepiece case in a state in which the decorative bezel is disposed around the timepiece case, and (ii) made of a brittle material.
